(19) United States
(12) Patent Application Publication
(10) Pub. No.: US 2023/0005076 A1
(43) Pub. Date: Jan. 5, 2023

(54) METHOD, APPARATUS, AND COMPUTER READABLE MEDIUM FOR DYNAMICALLY MODELING A CURRENT PRICE OF AN INVOICE ISSUED BY A SELLER BASED ON REAL-TIME MONITORING OF TRANSACTION DATA ON A COMPUTER NETWORK

(71) Applicant: AGORA INTELLIGENCE, INC., Santa Clara, CA (US)

(72) Inventor: Kevin HOPKINS, Sandy, UT (US)

(21) Appl. No.: 17/857,878

(22) Filed: Jul. 5, 2022

Related U.S. Application Data
(60) Provisional application No. 63/218,189, filed on Jul. 2, 2021.

(51) Int. Cl. G06Q 40/00; G06Q 40/08; G06Q 40/02

(52) U.S. Cl. CPC G06Q 40/12; G06Q 40/08; G06Q 40/02

(57) ABSTRACT

A method, apparatus, and computer-readable medium for dynamically modeling a current price of an invoice issued by a seller based on real-time monitoring of transaction data on a computer network, including receiving, invoice data corresponding to the invoice issued by the seller, the invoice data comprising a buyer identifier, a seller identifier, and invoice parameters, identifying a buyer profile on an invoice transactions platform on the computer network, the buyer profile comprising a buyer transaction history and the seller profile comprising a seller transaction history, determining a seller overall probability of default based on seller-default variables and dynamic seller-default weights associated with the seller-default variables, determining a buyer overall probability of default, and determining the current price of the invoice based on the seller overall probability of default, the buyer overall probability of default, and the one or more invoice parameters.

### CROSS-REFERENCE TO RELATED APPLICATION

This application claims benefit of priority to U.S. Provisional Application No. 63/218,189 filed Jul. 2, 2021, the disclosure of which is hereby incorporated by reference.

### BACKGROUND

In the context of invoice financing and this disclosure, the term seller refers to a company that is selling services/products and which obtains financing based upon their outstanding invoices. The term buyer refers to a company named on the outstanding invoices that owes an outstanding balance to the seller, typically a customer of the seller. Additionally, the term funder refers to a company or individual that provides funding to the seller utilizing the outstanding invoices and invoice balance as collateral.

There are currently no systems in place that provide a transparent and accurate view of the participants in the invoice financing marketplace and their behavior in that marketplace. Conventional funding/financing systems rely only credit scores and similar metrics which do not provide an accurate or reliable information about whether a particular seller will repay financing or the expected return associated with a particular seller in the relevant marketplace.

Additionally, as multiple parties are involved in invoice financing, the likelihood a particular seller providing a return on financing will also depend on the buyers to whom they have issued invoices. The behavior and records of buyers may vary greatly, not only with respect to other buyers but also with respect to different sellers. For example, a particular buyer may have a much better record with payment of invoices of a large company (i.e., a seller) than payment of invoices of a small proprietor (i.e., a different seller). Current systems do not track buyer information specific to certain sellers or provide any technology infrastructure to track or leverage this information.

The lack of data relating to parties involved in an invoice transaction, including buyers and sellers, makes it difficult to accurately price invoices. For example, the market value of an invoice having a reliable buyer and seller with good credit scores would be different than the market value of an invoice with delinquent buyers and sellers. However, there are currently no systems which can derive accurate buyer and seller metrics and utilize them for invoice pricing. Without accurate invoice pricing, invoices cannot be sold to funders, bundled, securitized, or otherwise utilized for financing purposes.

Accordingly, improvements are needed in technology systems for tracking, structuring, and storing data associated with the parties involved in invoice financing and for pricing individual invoices based upon the activity of those parties.

### BRIEF DESCRIPTION OF DRAWINGS

FIG. 1 illustrates a flowchart for dynamically modeling a current price of an invoice issued by a seller based on real-time monitoring of transaction data on a computer network according to an exemplary embodiment.

FIG. 2 illustrates a table showing possible invoice parameters and example values of these parameters according to an exemplary embodiment.

FIG. 3 illustrates an example of the buyer profile and invoice transaction history according to an exemplary embodiment.

FIG. 4 illustrates an example of the seller profile and invoice transaction history according to an exemplary embodiment.

FIG. 5 illustrates the use of seller invoice transaction history for determination of dynamic weights according to an exemplary embodiment.

FIG. 6 illustrates a flowchart for determining the current price of the invoice according to an exemplary embodiment.

FIGS. 7A-7H illustrate a sample invoice, model, and sample calculations and values according to an exemplary embodiment.

FIG. 8 illustrates an example of costs and returns relating to an invoice fund over a period of monthly cycles in a year according to an exemplary embodiment.

FIG. 9 illustrates the components of the specialized computing environment configured to perform the specialized processes described herein according to an exemplary embodiment.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, apparatus, and computer-readable medium for dynamically modeling a current price of an invoice issued by a seller based on real-time monitoring of transaction data on a computer network.

The present system allows for a determination of a probability of default for a seller and buyer that utilizes dynamic and shifting weighting of internal metrics and external metrics, whereby the balance of weighting to internal and external metrics shifts as a function of the quantity of transaction data stored on the system for the seller and its associated buyers. In particular, the most pertinent data for assessing risk is the data that pertains to the same type of transactions, on the same platform. For this reason, internal metrics are likely to have a higher reliability. These buyer and seller metrics can then be utilized for pricing invoices involving the buyers and sellers.

In the present system, when the number of transactions (repayment events) are low, the weighting is shifted to external metrics, which are relied upon largely as a proxy for the more relevant internal metrics that would likely have a higher reliability in estimating a probability of default. However, as the quantity of internal transactions increases, the reliability of the internal metrics increases as well, and the dynamic weighting shifts the weight so that internal metrics are given greater weighting than external metrics. This dynamic shifting weighting allows for accurate assessment of risk at all stages of experience and history, whether a seller is new to the platform or a more experienced member of the exchange. The system can actively monitor a quantity, quality, or other metric relating to transactions conducted on the network or stored in a database for a particular seller or buyer, and then dynamically shift weighting based on the detection of transactions or transaction metrics beyond a predetermined threshold.

The present system can also enables more granular and accurate assessment of probability of default and other risk metrics through the use of buyer data that is bound to buyer-seller pairings. In other words, internal transaction data and metrics for buyers are not divorced from the sellers to which they owe payment. Instead buyer metrics and transaction data records are linked to the data for specific sellers. This data linkage allows for more accurate assessment of buyer level risk due to default on invoices, since the behavior and data for a buyer may differ among different sellers. For example, buyer A may have a very good track record of timely payment to seller B on seller B's invoices while at the same time having a poor record of payment to seller C on seller C's invoices. This difference only becomes observable in the data set when the transaction data for buyer A is stored in a data structure which references or links to the specific seller for each transaction.

The present system utilizes and ultimately emphasizes metrics derived from internal real-time network transaction data to thereby provide greater visibility into the risk metrics for all parties to an invoice financing transaction and greater accuracy in the risk and probability of default assessment. The linked buyer-seller data structures, transaction data sets, and associated metrics also provide a level of transparency and accuracy in risk measurement that would not be possible without the specific linked records and real-time transaction data.

The use of internal real-time network transaction data allow for more accurate pricing of invoices. This pricing accurately captures the default risk and probability of repayment associated with each invoice, resulting in a more reliable current price for a particular invoice.

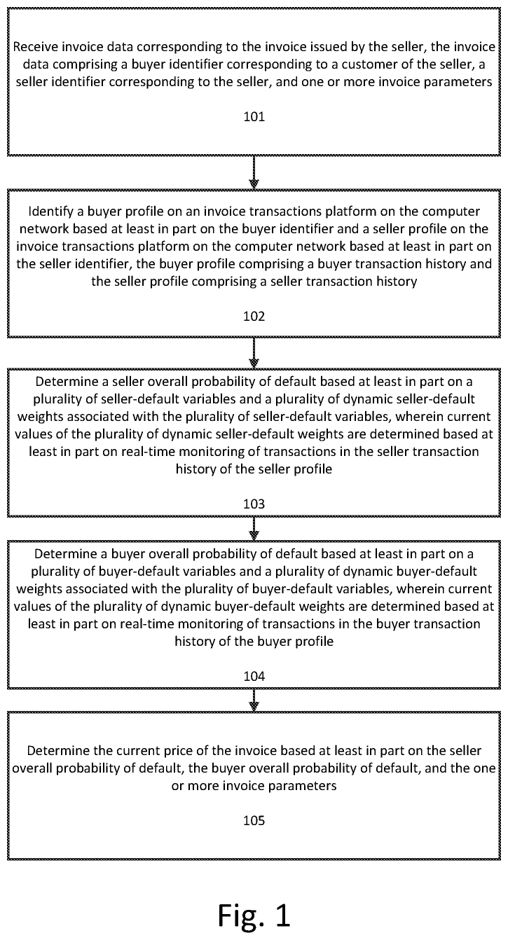

FIG. 1 illustrates a flowchart for dynamically modeling a current price of an invoice issued by a seller based on real-time monitoring of transaction data on a computer network according to an exemplary embodiment.

At step 101 invoice data corresponding to an invoice issued by the seller is received. The invoice data includes a buyer identifier corresponding to a customer of the seller and a seller identifier corresponding to the seller. Additionally, the received invoice data can include one or more invoice parameters. Optionally, one or more invoice parameters can be stored on the administrator system and can be applicable to all invoices (i.e., rather than being received as part of the invoice data).

The invoice parameters can include, for example, an invoice amount, an administrator fee, an insurance fee percentage, a uniform commercial code fee, a fee period, a maximum weekly interest rate, a maximum monthly interest rate, a base holdback percentage, a maximum base holdback percentage, an insurance repayment percentage, a fund size, a fund cycles parameter, an additional funding parameter, a funder profit retention flag, a funder profit retention percentage, an administrator profit retention flag, and/or an administrator profit retention percentage.

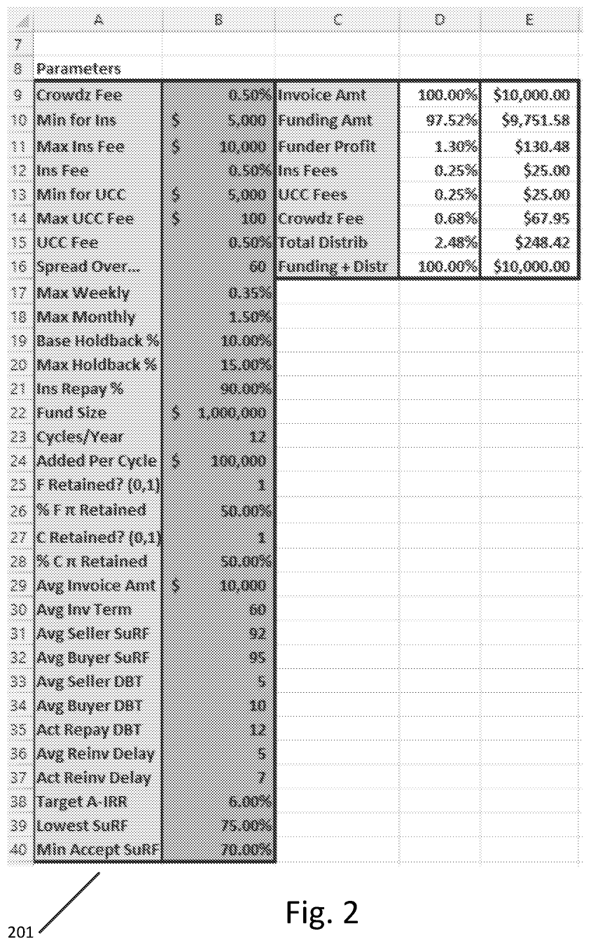

FIG. 2 illustrates a table showing possible invoice parameters and example values of these parameters according to an exemplary embodiment. Each of these invoice parameters are explained in greater detail below, with reference to the corresponding cells of table 201 in FIG. 2. These parameters can be specified on a per-invoice basis, can be set for batches of invoices, and/or can be set by an administrator.

Administrator fee/Crowdz fee (percentage), or the amount of profit the administrator (e.g., Crowdz) takes from the financing transactions, (Cell B9).

Invoice insurance fee (percentage), including the minimum invoice value against which the insurance fee is assessed and the maximum insurance fee that can be charged (Cells B10-B12).

UCC fee (percentage), including the minimum invoice value against which universal commercial code (UCC) fees are assessed and the maximum UCC fee that can be charged (Cells B13-B15).

The period over which fees are spread. For instance, if that period is 60 days and the invoice term is only 30 days, the invoice Seller is charged only 30/60 (0.5) of the fees that otherwise would be assessed (Cell B16).

Maximum weekly interest rate (percentage), or the maximum interest rate that Sellers can be charged for their invoices, calculated from their annual percentage rate (APR) to give a weekly rate (Cell B17).

Maximum monthly interest rate (percentage), or the maximum interest rate that Sellers can be charged for their invoices, calculated from their annual percentage rate (APR) to give a monthly rate (Cell B18).

Base Holdback %. The minimum amount of invoice funding that is initially held back for insurance purposes from transmission to the Seller to ensure against non-repayment, which may be but does not have to be keyed to the percentage of invoice-insurance indemnification (Cell B19).

Maximum Base Holdback %. The maximum insurance-related holdback percentage (Cell B20).

Insurance Repayment %. The percentage of any loss on invoice funding that is covered by invoice insurance (Cell B21).

Fund Size. The total initial value of an invoice fund to which invoices in the spreadsheet belong (Cell B22).

Cycles/Year. The number of fixed-period times per year that the fund is augmented annually, for projection purposes (Cell B23)

Added Per Cycle. The amount of additional funding that is added to the invoice fund during each cycle, for projection purposes (Cell B24).

F Retained? (0.1). Whether or not the Funder's per-invoice profit is retained in the invoice fund at each cycle, for projection purposes, with 0 indicating the profit is not retained and 1 indicating that it is (Cell B25).

% F π Retained. Percentage of the Funder's profit (π) from invoice sales retained in the invoice fund, for projection purposes, assuming any Funder profit is retained (Cell B26).

C Retained? (0.1). Whether or not the administrator's/Crowdz's per-invoice profit is retained in the invoice fund at each cycle, for projection purposes, with 0 indicating the profit is not retained and 1 indicating that it is (Cell B27).

% C π Retained. Percentage of the administrator's/Crowdz' profit (π) from invoice sales retained in the invoice fund, for projection purposes, assuming any Funder profit is retained (Cell B28).

Avg Invoice Amt. Average dollar-value of all invoices in the invoice fund, for estimation purposes (Cell B29).

Avg Inv Term. Average invoice term remaining for all invoices in the invoice fund, for estimation purposes (Cell B30).

Avg Seller SuRF. Average of Seller SuRF Scores for all invoices in the invoice fund, for estimation purposes (Cell B31). The SuRF Score is equivalent to the probability of repayment and the inverse of the probability of default/delinquency. In other words, the probability of default/delinquency=1−probability of repayment (SuRF Score).

Avg Buyer SuRF. Average of Buyer SuRF Scores for all invoices in the invoice fund, for estimation purposes (Cell B32).

Avg Seller DBT. Predicted average of Seller DBT (days beyond term, or lateness of payments/repayments) for all invoices in the invoice fund, for estimation purposes (Cell B33).

Avg Buyer DBT. Predicted average of Buyer DBT (days beyond term, or lateness of payments/repayments) for all invoices in the invoice fund, for estimation purposes (Cell B34).

Act Repay DBT. Actual average combined DBT (days beyond term, or lateness of payments/repayments) for all invoices in the invoice fund (Cell B35).

Avg Reinv Delay. Predicted average period between the time the invoice fund receives repayment of funding for a particular invoice and the time in which the received money is reinvested, for estimation purposes (Cell B36).

Act Reinv Delay. Actual average period between the time the invoice fund receives repayment of funding for a particular invoice and the time in which the received money is reinvested, for estimation purposes (Cell B37).

Target Annualized Internal Rate of Return (A-IRR). The percentage return (annualized, compounded daily) that the administrator/Crowdz wishes to offer investors in the financing of invoices (Cell B38).

Lowest Combined SuRF Score. The point in the range of SuRF Scores below which the score's effect on the Seller's APR is canceled out. For instance, for a Lowest Combined SuRF Score of 70%, any combined SuRF Scores below that level are treated as if they were 70%. (Cell C39).

Min Accept SuRF. The minimum combined SuRF Score that invoices must have (i.e., the minimum acceptable SuRF Score) in order to be funded by the invoice fund (Cell B40).

The parameters described above are used to automatically and dynamically customize the model so that both individual invoice-fund administrators' as well individual funders can precisely determine discount rates, holdbacks, and fees for individual invoices. That is, individual invoices receive precise funding offers based on the individual risk and other characteristics of each invoice—and these amounts are automatically determined and require no human intervention other than the selection of parameters.

Returning to FIG. 1, at step 102 a buyer profile is identified on an invoice transactions platform on the computer network based at least in part on the buyer identifier and a seller profile is also identified on the invoice transactions platform on the computer network based at least in part on the seller identifier. The buyer profile includes a buyer transaction history and the seller profile includes a seller transaction history.

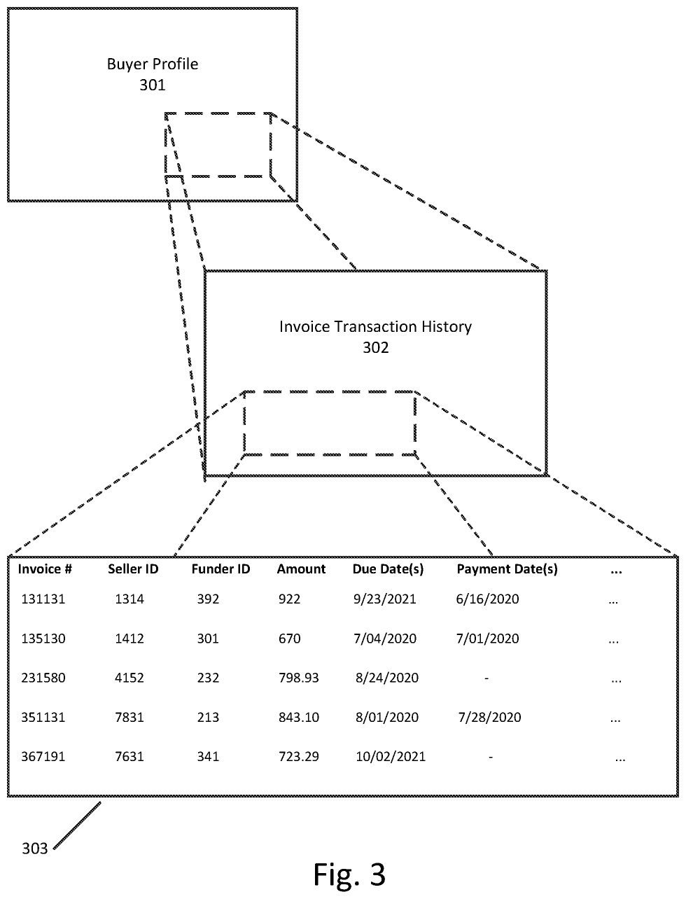

FIG. 3 illustrates an example of the buyer profile and invoice transaction history according to an exemplary embodiment. As shown in FIG. 3, buyer profile 301 includes invoice transaction history 302. Box 303 illustrates an example of a portion of the invoice transaction history. The transaction history can include, for example, invoice numbers/identifiers, seller identifiers associated with invoices, and invoice amounts. The transaction history also includes funder information associated with particular invoices, such as the identifier or name of a funder that previously provided funding pertaining to a particular invoice. The transaction history can include one or more due dates, such as the due date for the invoice amount, the due date of repayment of financing, etc. The transaction history can also include payment dates, such as the date of payment of the invoice by the buyer, the date of repayment of financing by the seller, etc. The transaction history can include additional information not shown in FIG. 3, such as invoice terms, conditions, invoice issue date, or any other pertinent information for the invoice, the buyer, the seller, or the funder.

The transaction history can record the following transactions (including their amounts, dates, timing, and parties):

Payment of an invoice by the Buyer to the Seller

Non-payment of an invoice by the Buyer to the Seller

Repayment of invoice-funding by the Seller to the Funder

Non-repayment of invoice-funding by the Seller to the Funder

Each new Buyer-Seller transaction (or non-transaction) and each new Seller-Funder transaction thereafter will be added to the various measures on an incremental basis until internal measurements and activities dominate buyer and seller risk metrics, as described in greater detail below.

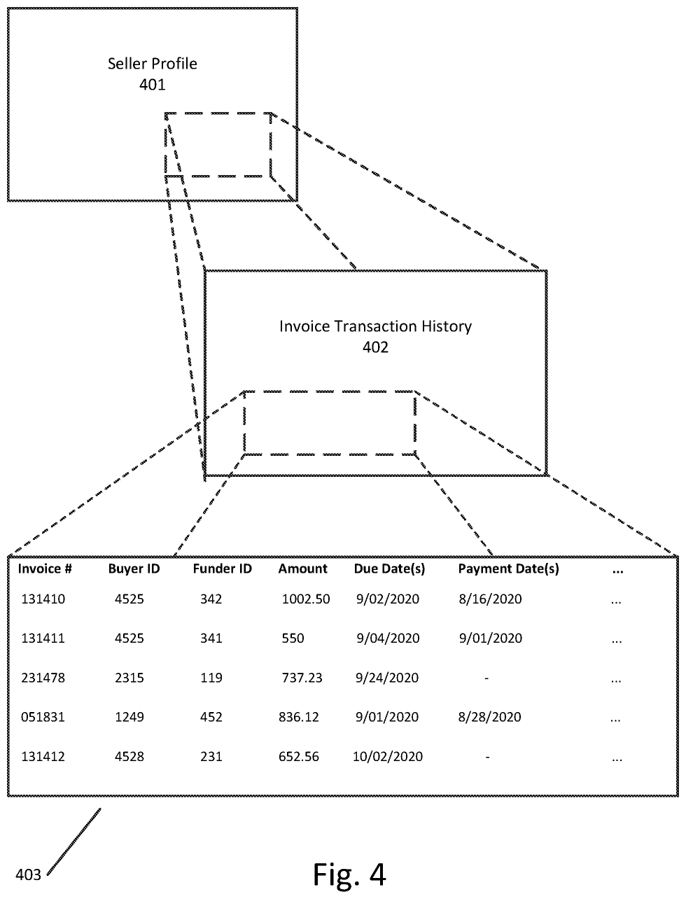

FIG. 4 illustrates an example of the seller profile and invoice transaction history according to an exemplary embodiment. As shown in FIG. 4, seller profile 401 includes invoice transaction history 402. Box 403 illustrates an example of a portion of the invoice transaction history. The transaction history can include, for example, invoice numbers/identifiers, buyer identifiers associated with invoices, and invoice amounts. The transaction history also includes funder information associated with particular invoices, such as the identifier or name of a funder that previously provided funding pertaining to a particular invoice. The transaction history can include one or more due dates, such as the due date for the invoice amount, the due date of repayment of financing, etc. The transaction history can also include payment dates, such as the date of payment of the invoice by the buyer, the date of repayment of financing by the seller, etc. The transaction history can include additional information not shown in FIG. 4, such as invoice terms, conditions, invoice issue date, or any other pertinent information for the invoice, the buyer, the seller, or the funder.

Similar to the buyer transaction history, the seller transaction history can record the following transactions (including their amounts, dates, timing, and parties):

Payment of an invoice by the Buyer to the Seller

Non-payment of an invoice by the Buyer to the Seller

Repayment of invoice-funding by the Seller to the Funder

Non-repayment of invoice-funding by the Seller to the Funder

Each new Buyer-Seller transaction (or non-transaction) and each new Seller-Funder transaction thereafter will be added to the various measures on an incremental basis until internal measurements and activities dominate buyer and seller risk metrics, as described in greater detail below.

The buyer invoice transaction history can also be extracted from a subset of the seller transaction history. For example, if a particular invoice has seller=XYZ and buyer=ABC, then the invoice transaction history for seller XYZ can be retrieved and filtered to identify all records relating to buyer ABC. In this way, the invoice transaction history can more accurately reflect the data and trends relating to a particular seller and buyer pairing.

Returning to FIG. 1, at step 103 a seller overall probability of default is determined based at least in part on a plurality of seller-default variables and a plurality of dynamic seller-default weights associated with the plurality of seller-default variables. The plurality of seller-default variables can include a seller integrity score, one or more secondary probability of default scores associated with the seller, and/or a seller internal probability of default. Current values of the plurality of dynamic seller-default weights are determined based at least in part on real-time monitoring of transactions in the seller transaction history of the seller profile.

Additionally, another metric that can be dynamically determined based upon the seller transaction history is the a seller overall projected days-beyond-term (DBT), which is a measure of how many days beyond term a seller is projected to pay the balance of the invoice. The seller overall projected DBT is based at least in part on a plurality of seller-DBT variables and a plurality of dynamic seller-DBT weights associated with the plurality of seller-DBT variables.

At step 104 a buyer overall probability of default based at least in part on a plurality of buyer-default variables and a plurality of dynamic buyer-default weights associated with the plurality of buyer-default variables. The plurality of buyer-default variables can include a buyer integrity score, one or more secondary probability of default scores associated with the buyer, and a buyer internal probability of default. Current values of the plurality of dynamic buyer-default weights are determined based at least in part on real-time monitoring of transactions in the buyer transaction history of the buyer profile.

Additionally, another metric that can be dynamically determined based upon the buyer transaction history is the a buyer overall projected days-beyond-term (DBT), which is a measure of how many days beyond term a buyer is projected to pay the balance of the invoice. The buyer overall projected DBT is based at least in part on a plurality of buyer-DBT variables and a plurality of dynamic buyer-DBT weights associated with the plurality of buyer-DBT variables.

The seller overall probability of default and project DBT can be based upon a seller internal probability of default (based upon data in the invoice transaction database) and internal projected DBT (based upon data in the invoice transaction database), as well as additional measures of probability default determined or projected DBT based on other scoring systems or public data about the seller. Similarly, the buyer overall probability of default and project DBT can be based upon a buyer internal probability of default (based upon data in the invoice transaction database) and internal projected DBT (based upon data in the invoice transaction database), as well as additional measures of probability default determined or projected DBT based on other scoring systems or public data about the buyer. Additionally examples and explanations relating to the determination of these measures can be found in U.S. Provisional Application No. 63/075,513, previously incorporated by reference.

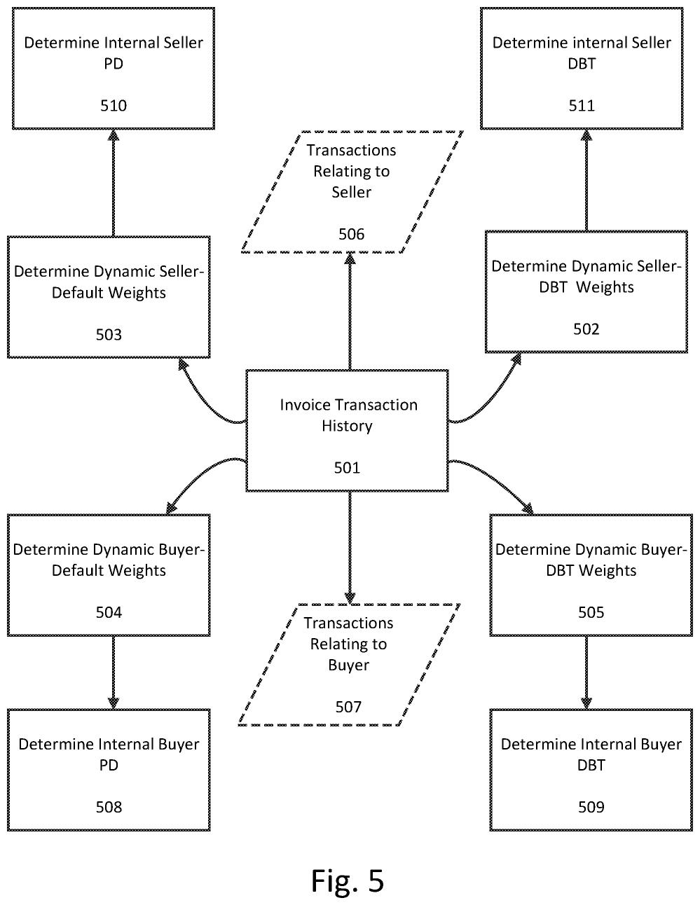

As explained above, the present system utilizes real-time monitoring of invoice transaction history of a seller and also the transaction history of seller with a particular buyer. FIG. 5 illustrates the use of seller invoice transaction history for determination of dynamic weights according to an exemplary embodiment.

As shown in FIG. 5, transactions relating to a seller 506 are extracted/filter/monitored from the invoice transaction history 501 and used to determine dynamic seller-default weights 503 and determine dynamic seller-DBT weights 502. These, in turn are used to determine the internal seller probability of default 510 and determine the internal seller projected days beyond term 511.

Similarly, transactions relating to a seller and buyer 507 are extracted/filter/monitored from the invoice transaction history 501 and used to determine dynamic buyer-default weights 504 and determine dynamic buyer-DBT weights 505. These are then used to determine internal buyer probability of default 308 and to determine internal buyer projected days beyond term 509.

The Seller's Internal Probability of Default is determined based on the invoice transaction history of the seller and, in an exemplary embodiment, can be given by the equation:

IPD_{S}=[(A₁*IPS₁)+(A₂*IPS₂)+ . . . +(A_{N}*IPS_{N})]/[A₁+A₂+ . . . +A_{N}]

where:

Aᵢ=the amount of invoice funding i

IPSᵢ=the internal payment status for invoice-funding i, that is, whether the invoice-funding amount was repaid (IPSᵢ=0) or unrepaid (IPSᵢ=1), as described above, within 90 days of its due date, for all invoice-funding repayments over the previous two years. Of course, other periods of time can be utilized.

Of course, other formulations can be utilized which also leverage the invoice transaction history associated with the seller to determine the seller internal probability of default.

A seller overall probability of default can be determined based at least in part on a plurality of seller-default variables and a plurality of dynamic seller-default weights associated with the plurality of seller-default variables. The plurality of seller-default variables can include a seller integrity score, one or more external probability of default scores associated with the seller, and the seller internal probability of default.

In an exemplary embodiment, the seller overall probability of default (PDₛ) can be determined by the equation:

PD_{S}=CIS_{S}*[(aⱼ*AVERAGE(DBDS_{S},CPDS_{S},IPHDS_{S}))+(bⱼ*IPD_{S})]

As shown above, the PD value is determined based at least in part on a plurality of seller-default variables, including CIS, DBDS, CPD, IPHDS, IPD (internal probability of default, discussed above) and a plurality of dynamic seller-default weights aⱼ and bⱼ. Each of these are explained below in greater detail.

CIS is the company integrity score. Company Integrity Scores (CISs) measure the likelihood that the company in question is legitimate, is operating in good faith, and raises no “red flags.” Assessing a company's CIS involves automated inspection of:

The registrant's identity and liveness verification;

Assessment of whether registrant is a real or synthetic person;

The company's KYB (Know Your Business) score;

The company's AML (Anti-Money Laundering) score;

The KYC (Know Your Customer) score for the individual and the company's beneficial owners; and

In certain cases, individual credit checks for beneficial owners.

The above-mentioned CIS-related metrics can be assessed in a variety of ways, such as identity verification measures, review of registration documentation, checks with public systems tracking company information, etc.

The overall probability of default (PD) determination can also utilizes an average of several secondary probability of default scores. These include the Dun & Bradstreet (D&B) Delinquency Score (DBDS), the Crowdz Probability of Default Score (CPDS) developed by Crowdz, and the Seller's Invoice-Payment History Default Score (IPHDS), which is based on data extracted from the Seller's accounting system. For example, all invoiced Seller payments and non-payments to its suppliers or other creditors for the past two years can be utilized to determine IPHDS. Of course, other periods of time can be utilized.

The coefficients aⱼ and bⱼ are dynamic seller-default weights and are regressed as a function of the number of repayment events over the past two years. Of course, other periods of time can be utilized. Until such a regression equation can be estimated, we can define:

aⱼ=0.3+[(0.7*MAX(20−j,0))/20] and

bⱼ=0.7*[MIN(20,j)/20]

For instance, if j=10 (that is, if 10 transactions have been completed in the past two years), then:

$$\begin{matrix}{a}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] = 0.3 + [ 7 / 20 ] = 0.3 + 0.35 = 0.65\end{matrix} \\ \begin{matrix}{b}_{j} = 0.7 * [ MIN ( 20 , 10 ) / 20 ] \\ = 0.7 * [ 10 / 20 ] = 0.7 * 0.5 = 0.35\end{matrix}$$

As a result:

aⱼ+bⱼ=0.65+0.35=1.0

The dynamic weight parameters assign greater weight to the internal, repayment-focused metric and lesser weight to the external metrics as the number of repayment events, j, grows larger.

As shown in the equation above, the plurality of dynamic seller-default weights comprise a first dynamic weight associated with the seller internal probability of default and a second dynamic weight associated with the one or more secondary probability of default scores. Since the value of the first dynamic weight increases relative to a value of the second dynamic weight as the quantity of transactions in the invoice transaction history of the seller profile increase, a greater reliance is place on internal data on the transaction network as the quantity of transactions in the invoice transaction history of the seller profile increase.

The Seller's Internal Projected Days Beyond Term (IDBT_{S})—or the average days beyond term for internal transactions—is calculated similarly to both the Seller's Projected Invoice-Payment History Based Days Beyond Term (DBT_{SH}) and Internal Probability of Default (IPD_{S}), and is defined using:

Aₙ=Amount of the funding for invoice

IDBT_{Sn}=Aggregate timing (Days Beyond Term) of Seller's repayment of the invoice-funding for Invoice n, where “paid on time”=200, “paid x days late”=200−x (with 0 being the lowest permissible value), and “paid y days early”=200+y

The system then calculates the Seller's Internal Projected Days Beyond Term for the Seller's invoice-funding repayments (IDBT_{SH}) as follows:

IDBT_{S}=[(IDBT_{S1}A₁)+(IDBT_{S2}*A₂)+ . . . +(IDBT_{SN}*A_{N})]/(A₁+A₂+ . . . +A_{N})

At step 103B a seller overall projected DBT is determined based at least in part on a plurality of seller-DBT variables and a plurality of dynamic seller-DBT weights associated with the plurality of seller-DBT variables. The plurality of seller-DBT variables include the seller internal projected DBT and one or more external DBT values associated with the seller.

The Seller Overall Projected Days Beyond Term (DBT) is calculated as:

DBT_{S}=f(AVERAGE(DBT_{SP},DBT_{SH}),IDBT_{S}) or more specifically:

DBT_{S}=(pᵢ*AVERAGE(DBT_{SP},DBT_{SH}))+(qᵢ+IDBT_{S})

As shown above, the plurality of seller-DBT variables include the seller internal projected DBT (IDBT) and one or more secondary DBT values associated with the seller. In this example, the one or more secondary DBT values include the Sellers Overall Paydex Score (DBT_{SP}) and the Seller's Projected Timing of Repayment (DBT_{SH}).

The overall DBT is also determined based upon a plurality of dynamic seller-DBT weights associated with the plurality of seller-DBT variables (pᵢ and qᵢ). The current values of the plurality of dynamic seller-DBT weights are determined based at least in part on real-time monitoring of transactions in the invoice transaction history of the seller profile

The coefficients pⱼand qⱼ are regressed as a function of the number of repayment events over the past two years. Of course, other periods of time can be utilized. Until such a regression equation can be estimated, we will define:

pⱼ=0.3+[(0.7*MAX(20−j,0))/20] and

qⱼ=0.7*[MIN(20,j)/20]

For instance, if j=10 (that is, if 10 transactions have been completed in the past two years), then:

$$\begin{matrix}{p}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix} \\ \begin{matrix}{q}_{j} = 0.7 * [ MIN ( 20 , 10 ) / 20 ] \\ = 0.7 * [ 10 / 20 ] \\ = 0.7 * 0.5 \\ = 0.35\end{matrix}$$

As a result:

$$\begin{matrix}{p}_{j} + {q}_{j} = 0.65 + 0.35 \\ = 1.\end{matrix}$$

As before, the various parameters assign greater weight to the internal, repayment-focused metric and lesser weight to the external metrics as the number of repayment events, j, grows larger.

The current values of the plurality of dynamic seller-DBT weights are determined based at least in part on real-time monitoring of transactions in the invoice transaction history of the seller profile. The plurality of dynamic seller-DBT weights include a first dynamic weight associated with the seller internal projected DBT and a second dynamic weight associated with the one or more external DBT values associated with the seller. A value of the first dynamic weight increases relative to a value of the second dynamic weight as the quantity of transactions in the invoice transaction history of the seller profile increase.

The Buyer's Internal Probability of Default (IPD) is calculated similarly to the Seller's corresponding metric, except that the Buyer's version has no Crowdz Probability of Default in it. The Buyer's Internal Probability of Default, IPD_{B}, is given by:

IPD_{B}=[(A₁*IPS₁)+(A₂*IPS₂)+ . . . +(A_{N}*IPS_{N})]/[A₁+A₂+ . . . +A_{N}]

where:

Aᵢ=the amount of invoice i

IPSᵢ=the internal payment status for invoice i, that is, whether the invoice amount was paid (IPSᵢ=0) by the buyer or unpaid (IPSᵢ=1), as described above, within 90 days of its due date, for all invoice payments due over the previous two years. Of course, other periods of time can be utilized.

The buyer overall probability of default is determined based at least in part on a plurality of buyer-default variables and a plurality of dynamic buyer-default weights associated with the plurality of buyer-default variables. The plurality of buyer-default variables including a buyer integrity score, one or more external probability of default scores associated with the buyer, and the buyer internal probability of default.

The probability of default is given by:

PD_{B}=CIS_{B}*PD_{BP}=CIS_{B}*f(AVERAGE(DBDS_{B},IPHDS_{B}),IPD_{B})

or more specifically:

PD_{B}=CIS_{B}*PD_{BP}=CIS_{B}*[(aⱼ*AVERAGE(DBDS_{B},IPHDS_{B}))+(bⱼ*IPD_{B})]

As shown above, the PD is based upon buyer-default variables and a plurality of dynamic buyer-default weights (aⱼ and bⱼ) associated with the plurality of buyer-default variables. The buyer-default variables include company integrity score (CIS), one or more secondary probability of default scores associated with the buyer (DBDS and IPHDS), and the buyer internal probability of default.

The coefficients aⱼ and bⱼ are regressed as a function of the number of payment events over the past two years. Of course, other periods of time can be utilized. Until such a regression equation can be estimated, we will define:

aⱼ=0.3+[(0.7*MAX(20−j,0))/20] and

bⱼ=0.7*[MIN(20,j)/20]

For instance, if j=10 (that is, if 10 transactions have been completed in the past two years), then:

$$\begin{matrix}{a}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix} \\ \begin{matrix}{b}_{j} = 0.7 * [ MIN ( 20 , 10 ) / 20 ] \\ = 0.7 * [ 10 / 20 ] \\ = 0.7 * 0.5 \\ = 0.35\end{matrix}$$

As a result:

$$\begin{matrix}{a}_{j} + {b}_{j} = 0.65 + 0.35 \\ = 1.\end{matrix}$$

The parameters assign greater weight to the internal, payment-focused metric and lesser weight to the external metrics as the number of payment events, j, grows larger.

As shown above, the plurality of dynamic buyer-default weights include a first dynamic weight associated with the buyer internal probability of default and a second dynamic weight associated with the one or more secondary probability of default scores associated with the buyer and a value of the first dynamic weight increases relative to a value of the second dynamic weight as the quantity of transactions associated with the buyer and seller in the invoice transaction history of the seller profile increase.

Current values of the plurality of dynamic buyer-default weights are determined based at least in part on real-time monitoring of transactions associated with both the seller and the buyer in the invoice transaction history of the seller profile. The plurality of dynamic buyer-default weights include a first dynamic weight associated with the buyer internal probability of default and a second dynamic weight associated with the one or more external probability of default scores associated with the buyer. A value of the first dynamic weight increases relative to a value of the second dynamic weight as the quantity of transactions associated with the buyer and seller in the invoice transaction history of the seller profile increase.

The buyer internal projected Days Beyond Term (DBT) is determined based at least in part on a portion of the invoice transaction history associated with both the buyer and the seller or upon the invoice transaction history associated with just the buyer (which may be less accurate but can be used based upon sample size).

The Buyer's Internal Projected Days Beyond Term (IDBT_{S})—or the average days beyond term for internal is defined using:

Aₙ=Amount of the funding for invoice

IDBT_{Bn}=Aggregate timing (Days Beyond Term) of Buyer's payment of the invoice amount for Invoice n, where “paid on time”=200, “paid x days late”=200−x (with 0 being the lowest permissible value), and “paid y days early”=200+y

The system then calculates the Buyer's Internal Projected Days Beyond Term for the Buyer's invoice payment (IDBT_{BH}) as follows:

IDBT_{B}=[(IDBT_{B1}*A₁)+(IDBT_{B2}*A₂)+ . . . +(IDBT_{BN}*A_{N})]/(A₁+A₂+ . . . +A_{N})

A buyer overall projected DBT is determined based at least in part on a plurality of buyer-DBT variables and a plurality of dynamic buyer-DBT weights associated with the plurality of buyer-DBT variables, the plurality of buyer-DBT variables comprising the buyer internal projected DBT and one or more external DBT values associated with the buyer.

The Buyer Overall Projected Days Beyond Term (DBT) is calculated as:

DBT_{B}=f(AVERAGE(DBT_{BP},DBT_{BH}),IDBT_{B}) or more specifically:

DBT_{B}=(pᵢ*AVERAGE(DBT_{BP},DBT_{BH}))+(qᵢ+IDBT_{B})

As shown above, the plurality of buyer-DBT variables include the buyer internal projected DBT (IDBT) and one or more secondary DBT values associated with the buyer. In this example, the one or more secondary DBT values include the Buyers Overall Paydex Score (DBT_{BP}) and the Buyer's Projected Timing of Repayment (DBT_{BH}).

The overall DBT is also determined based upon a plurality of dynamic buyer-DBT weights associated with the plurality of buyer-DBT variables (pᵢ and qᵢ). The current values of the plurality of dynamic buyer-DBT weights are determined based at least in part on real-time monitoring of transactions in the invoice transaction history of the buyer profile

The coefficients pⱼ and qⱼ are regressed as a function of the number of payment events over the past two years. Of course, other periods of time can be utilized. Until such a regression equation can be estimated, we will define:

pⱼ=0.3+[(0.7*MAX(20−j,0))/20] and

qⱼ=0.7*[MIN(20,j)/20]

For instance, if j=10 (that is, if 10 transactions have been completed in the past two years), then:

$$\begin{matrix}{p}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix} \\ \begin{matrix}{q}_{j} = 0.7 * [ MIN ( 20 , 10 ) / 20 ] \\ = 0.7 * [ 10 / 20 ] \\ = 0.7 * 0.5 \\ = 0.35\end{matrix}$$

As a result:

$$\begin{matrix}{p}_{j} + {q}_{j} = 0.65 + 0.35 \\ = 1.\end{matrix}$$

As before, the various parameters assign greater weight to the internal, repayment-focused metric and lesser weight to the external metrics as the number of repayment events, j, grows larger.

Current values of the plurality of dynamic buyer-DBT weights are determined based at least in part on real-time monitoring of transactions in the invoice transaction history of the buyer profile. The plurality of dynamic buyer-DBT weights include a first dynamic weight associated with the buyer internal projected DBT and a second dynamic weight associated with the one or more external DBT values associated with the buyer. A value of the first dynamic weight increases relative to a value of the second dynamic weight as the quantity of transactions associated with the buyer and the seller in the invoice transaction history of the seller profile increase.

Returning to FIG. 1, at step 105 the current price of the invoice is determined based at least in part on the seller overall probability of default, the buyer overall probability of default, and the one or more invoice parameters.

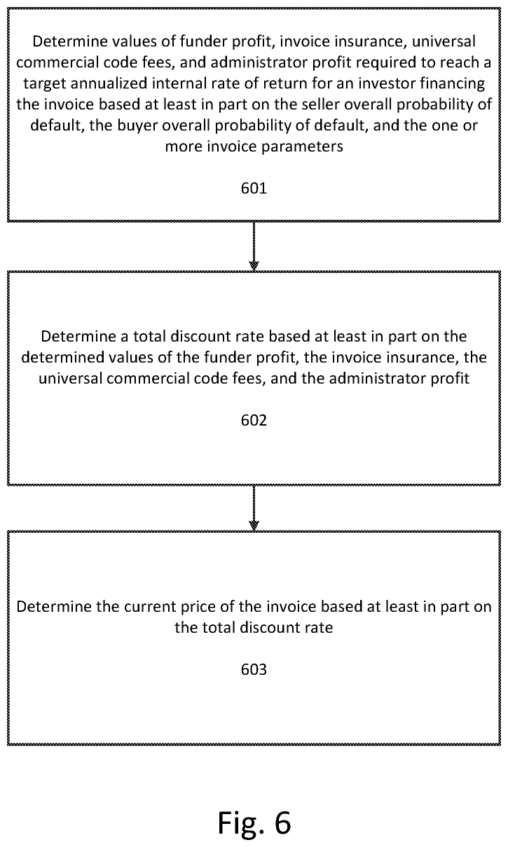

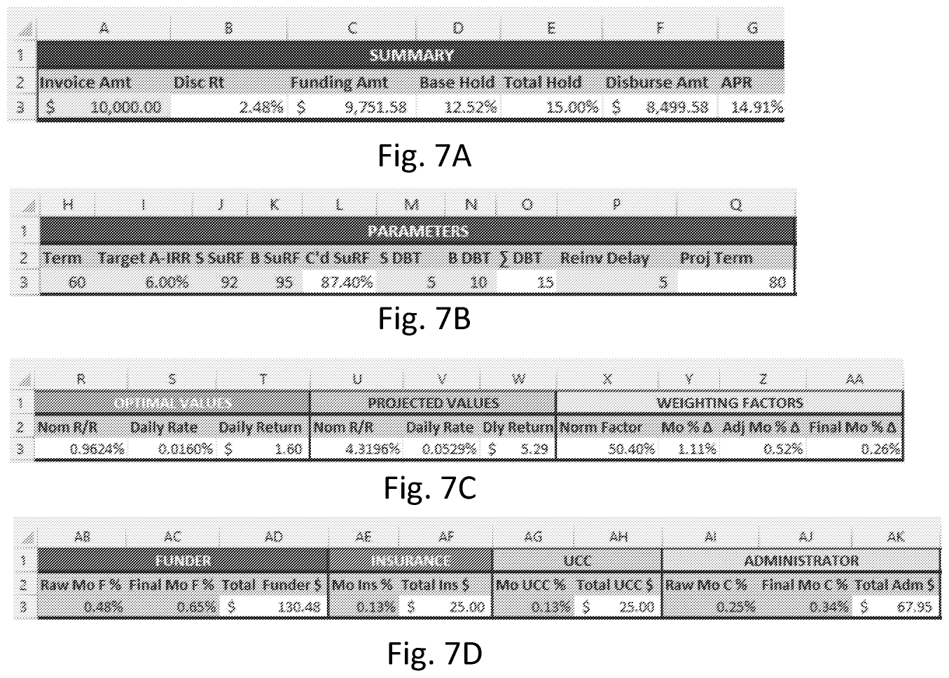

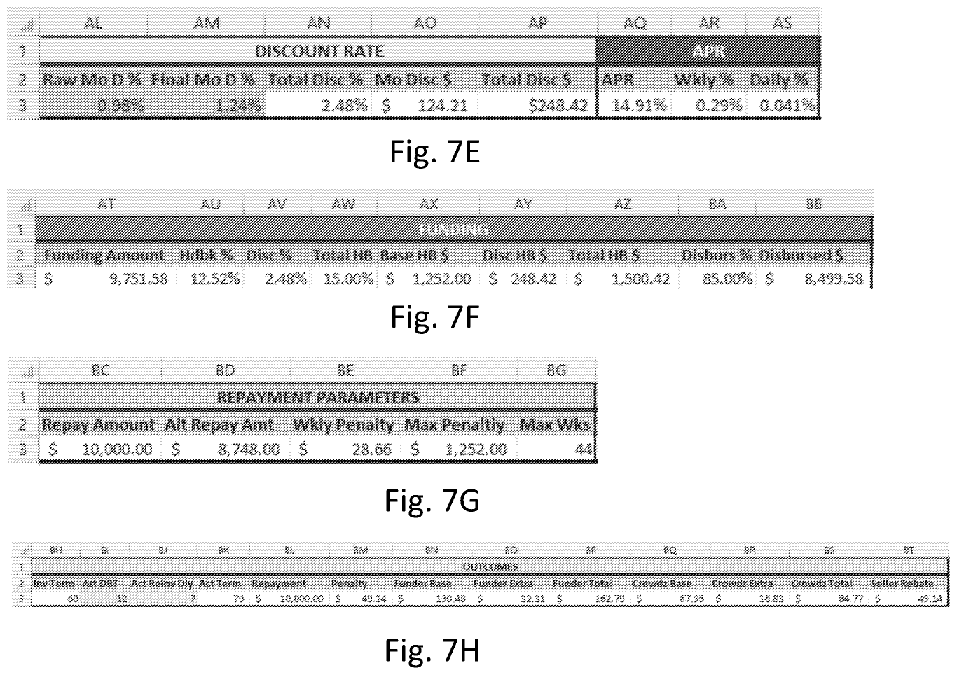

FIG. 6 illustrates a flowchart for determining the current price of the invoice according to an exemplary embodiment. Each of the steps are described briefly below and explained in greater detail with respect to FIGS. 7A-7H.

At step 601 values of funder profit, invoice insurance, universal commercial code fees, and administrator profit required to reach a target annualized internal rate of return for an investor financing the invoice are determined based at least in part on the seller overall probability of default, the buyer overall probability of default, and the one or more invoice parameters.

At step 602 a total discount rate is determined based at least in part on the determined values of the funder profit, the invoice insurance, the universal commercial code fees, and the administrator profit.

At step 603 the current price of the invoice is determined based at least in part on the total discount rate. This step can include multiplying an invoice amount by the total discount rate to determine a discount value and subtracting the discount value from the invoice amount to determine the current price of the invoice.

The method of dynamically modeling a current price of an invoice issued by a seller based on real-time monitoring of transaction data on a computer network will now be explained in greater detail with respect to a sample invoice, the model, and sample calculations and values, as shown in FIGS. 7A-7H. For the purpose of this explanation, several of the invoice calculations described will utilize the parameter set and table and cells shown in FIG. 2. The dynamic pricing model's operation is broken down into a number of sections, described below.

### SUMMARY

The Summary section is shown in FIG. 7A and includes the primary inputs and outputs of the model:

Invoice Amount (Column A). The face value of each invoice or other receivable either included in or proposed for inclusion in the fund. For estimation purposes, this column derives its value from Cell B29 in FIG. 2; alternatively, it can be manually entered or drawn from a spreadsheet or database of individual invoices for active calculation for the Invoice Fund.

Discount Rate (Column B). The total proportion of the invoice amount that the Invoice Seller must sacrifice in order to receive early payment of the balance of the invoice's value. This value is determined in Column AN, as described below.

Funding Amount (Column C). The amount that the invoice Seller would receive if there were no holdback. This value is determined in Column AT, as described below.

Base Hold (Column D). This is the total percentage holdback for insurance purposes (i.e., to ensure that the Funder and Invoice Fund owner receives the contemplated fees and is otherwise made whole if the Seller defaults on repayment of the invoice funding and the Funder and/or Invoice Fund owner must file an invoice-insurance claim. This value is determined in Column AU, as described below.

Total Hold (Column E). This is the sum of the Discount Rate (Column B) and Base Holdback (Column D), and represents the total percentage of the invoice value that is not supplied to the Seller at the time of initial funding, and includes the amount held back and will be supplied to the Seller upon funding-repayment, and that is held back as the cost of funding and will not be supplied to the Seller. The total hold is the discount rate+the base hold.

Disburse Amount (Column F). This is the amount that the Seller receives (i.e., that is disbursed by the Funder of Invoice Fund administrator) at the time of funding. This value is determined in Column BB, as described below.

APR (Column G). This is the annual percentage rate that the Invoice Seller pays for a given invoice for the privilege of receiving early-payment (i.e., invoice financing). This value is determined in Column AQ, as described below.

### Parameters

The Parameters section is shown in FIG. 7B and includes the major, invoice-specific parameters that are derived from either the risk (SuRF Score) model or the parameter set described earlier:

Term (Column H). This is the remaining term of the invoice. For estimation purposes, this column derives its value from Cell B30; alternatively, it can be manually entered or drawn from a spreadsheet or database of individual invoices for active calculation for the Invoice Fund.

Target IRR (Column I). This is the target annualized internal rate of return (A-IRR) that the Funder and/or Invoice Fund administrator desires to receive from invoice-funding endeavors. For estimation purposes, this column derives its value from Cell B38; alternatively, it can be manually entered, drawn from a table of general parameters, or drawn from a spreadsheet or database of individual invoices for active calculation for the Invoice Fund.

S SuRF (Column J). This is the Invoice Seller's SuRF Score. For estimation purposes, this column can derive its value from Cell B31. In that case, it is determined as (Seller SuRF Score*Buyer SuRF Score)/(100*100). Alternatively, it can be manually entered or drawn from a spreadsheet or database of individual invoices for active calculation for the Invoice Fund.

B SuRF (Column K). This is the Buyer's (i.e., Invoice Seller's customer) SuRF Score. For estimation purposes, this column derives its value from Cell B32; alternatively, it can be manually entered or drawn from a spreadsheet or database of individual invoices for active calculation for the Invoice Fund.

C'd SuRF (Column L). This is the combined SuRF Score (i.e., the combination of the Seller's and Buyer's SuRF Scores). It is the product of the Seller's and Buyer's SuRF Scores divided by (100×100) and transformed into a percentage. Other formulas can be employed as well, either prospectively or as the result of predictiveness fine-tuning.

S DBT (Column M). This is the Invoice Seller's DBT (days beyond term) Score. For estimation purposes, this column derives its value from Cell B31; alternatively, it can be manually entered or determined from a spreadsheet or database of individual invoices for active calculation for the Invoice Fund, as described earlier.

B DBT (Column N). This is the Buyer's (i.e., Invoice Seller's customer) DBT (days beyond term) Score. For estimation purposes, this column derives its value from Cell B34; alternatively, it can be manually entered or drawn from a spreadsheet or database of individual invoices for active calculation for the Invoice Fund.

ΣDBT (Column O). This is the combined DBT Score (i.e., the combination of the Seller's and Buyer's DBT Scores). It is the sum of the Seller's and Buyer's DBT Scores. Other formulas can be employed as well, either prospectively or as the result of predictiveness fine-tuning.

Reinv Delay (Column P). This is the delay in the Funder's and/or Invoice Fund administrator's reinvesting of the repaid invoice funding. For estimation purposes, this column derives its value from Cell B36; alternatively, it can be manually entered or drawn from a spreadsheet or database of individual invoices for active calculation for the Invoice Fund.

Proj Term (Column Q). This is the projected number of days from the due date of the invoice (and, hence, the due date of the repayment at which the Funder and/or Invoice Fund administrator can expect to receive repayment of the invoice funding. This is the sum of the combined DBT Score and the reinvestment delay for a given invoice. This is calculated as the sum of the term (column H), the total DBT (Column O), and the reinvestment delay (column P).

### Optimal Values

These are shown in FIG. 7C and are the values that would be obtained if the Target A-IRR is met for a given invoice, there is no delay in repayment, and there is a 100% probability of repayment:

Nom R/R (Column R). This is the optimal nominal rate of return that would result if the Target A-IRR were met for a given invoice, there were no delays in repayment, and the probability of repayment were 100%—that is, the rate of return over the life of the projected financing term. The optimal nominal rate of return is calculated as shown in Cell R3 of the spreadsheet, where EXP is the exponential function and LN is the natural logarithmic function, or the inverse of the exponential function). The calculation draws on the values of the remaining term (Column H) and Target A-IRR (Column I) and is given by EXP (Term*LN((Target A-IRR+1)/1)/365)−1, where EXP stands for exponent.

Daily Rate (Column S). This the optimal daily rate of return that would result if the Target A-IRR were met for a given invoice, there were no delays in repayment, and the probability of repayment were 100%. It can be calculated by reducing the optimal nominal rate of return (Column R) to a daily rate using the remaining term (Column H). The daily rate of return is calculated as (LN(1+NOM R/R)/Term)−1, where EXP is the exponential function and LN is the natural logarithmic function, or the inverse of the exponential function).

Daily Return (Column T). This is the optimal daily return in monetary values if the Target A-IRR were met for a given invoice, there were no delays in repayment, and the probability of repayment were 100%. It is the product of the Daily Rate (Column S) and the Invoice Amount (Column A).

### Projected Values

These are shown in FIG. 7C and are the values that would be obtained if the Target A-IRR is met for a given invoice but that there are delays in repayment and reinvestment as projected and there is probability of repayment as projected by the combined SuRF Scores:

Nom R/R (Column U). This is the projected nominal rate of return that would result if the Target A-IRR were met for a given invoice, there were delays in repayment and reinvestment as projected, and there were a probability of repayment as projected by the combined SuRF Score—that is, the rate of return over the life of the projected financing term. The projected nominal rate of return is calculated as shown in Cell U3 of the spreadsheet, where EXP is the exponential function and LN is the natural logarithmic function, or the inverse of the exponential function). The calculation draws on the values of the projected term (Column Q), Target A-IRR (Column I), and combined SuRF Score (Column L), the latter of which indicates the projected probability of repayment. Specifically, it can be calculated as EXP (Proj. Term*LN((Target A-IRR+1)/Combined SuRF Score)/365)−1.

Daily Rate (Column V). This the projected daily rate of return that would result if the Target A-IRR were met for a given invoice, there were delays in repayment and reinvestment as projected, and there were a probability of repayment as projected by the combined SuRF Score. It can be calculated by reducing the projected nominal rate of return (Column U) to a daily rate using the projected term (Column Q). The daily rate of return is calculated as shown in Cell V3 of the spreadsheet, where EXP is the exponential function and LN is the natural logarithmic function, or the inverse of the exponential function). Specifically, the daily rate is determined as EXP(LN(1+Nom R/R)/Proj. Term)−1.

Daily Return (Column W). This is the projected daily return in monetary values if the Target A-IRR were met for a given invoice, there were delays in repayment and reinvestment as projected, and there were a probability of repayment as projected by the combined SuRF Score. It is the product of the Daily Rate (Column S) and the Invoice Amount (Column A).

### Weighting Factors

These are shown in FIG. 7C and are factors that are used to weight the daily rate of return required to achieve the Target A-IRR as a result of constraints imposed on the calculations by certain parameters, as described above:

Norm Factor (Column X). This is a normalizing factor that adjusts calculations to satisfy the fact that no SuRF Score can fall below the Lowest SuRF Score (Cell B39). It can be calculated as follows: if the combined SuRF Score (column L) is greater than the lowest acceptable SuRF (cell B39), then the normalization factor is (1−the combined SuRF Score)/(1−the lowest acceptable SuRF). Otherwise, the normalization factor is set to one or inverted ((1−the lowest acceptable SuRF)/(1−the combined SuRF Score)).

Mo % Δ (Column Y). This is the monthly difference (delta) between the optimal and projected daily rates of return. It can be calculated as ((1+(Daily Rate Projected−Daily Rate Optimal))\hat{ }30)−1.

Adj Mo % Δ (Column Z). This is the adjusted monthly difference (delta) between the optimal and projected daily rates of return. The adjustment made is to keep the monthly discount rate below the maximum monthly discount rate (Cell B18). The calculation is the minimum value between either (1) the max monthly discount rate (Cell B18)−the raw monthly discount rate (column AL), or (2) the monthly difference (delta) (column Y).

Final Mo % Δ (Column AA). This is the final monthly difference (delta) between the optimal and projected daily rates of return. It is the product of the Normalizing Factor (Cell X3) and the adjusted monthly difference (delta−Cell Z3) between the optimal and projected daily rates of return.

### Discount Rate Determination

These calculations are shown in FIGS. 7D-7E and are used to determine the discount rate—including the costs of Funder profit, invoice insurance, universal commercial code (UCC) lookup, and the profit of Crowdz or other Invoice Fund administrator—that are required to deliver the Target A-IRR, as conditioned by the various parameters, described above:

Funder (FIG. 7D):

Raw Mo F % (Column AB). This is the raw (unadjusted) projected monthly Funder rate of return, as determined by the optimal daily rate of return. It can be calculated as ((1+S3)\hat{ }30)−1, where S3 refers to the Daily Rate column.

Final Mon F % (Column AC). This is the final (adjusted) projected monthly Funder rate of return, as determined by the optimal daily rate of return as adjusted by the final projected monthly delta, as described above, and the raw Crowdz/administrator projected monthly rate of return, described below. It can be calculated as AB3+(AB3/(AB3+AI3))*AA3, where AB, AI, and AA refer to the columns and/or cells shown in FIGS. 2 and 7A-7H.

Total Funder $ (Column AD). This is the total Funder profit (return), based on the final projected monthly Funder rate of return (Column AC), the invoice amount (Column A), and the remaining term (Column H). It can be calculated as (AC3*A3)*(H3/30), where AC, A, and H refer to the columns and/or cells shown in FIGS. 2 and 7A-7H.

Insurance (FIG. 7D):

Mo Ins % (Column AE). This is the monthly invoice insurance percentage fee, as determined by the various parameters and constraints described above. It can be calculated as follows: IF H3<60 THEN it equals (AF3/A3)/(MAX(H3,B16)/30)/(H3/60) ELSE it equals (AF3/A3)/(MAX(H3,B16)/30)), where AF, A, H, and B refer to the columns and/or cells shown in FIGS. 2 and 7A-7H.

Total Ins $ (Column AF). This is the total insurance amount that must be paid for the invoice financing, as determined by the various parameters and constraints described above. It can be calculated as (MAX(A3−B10,0)*B12) where A and B refer to the columns and/or cells shown in FIGS. 2 and 7A-7H.

UCC (FIG. 7D):

Mo UCC % (Column AG). This is the monthly UCC percentage fee, as determined by the various parameters and constraints described above. It can be calculated as follows: IF H3<60 THEN it equals (AH3/A3)/(MAX(H3,B16)/30)/(H3/60) ELSE it equals (AH3/A3)/(MAX(H3,B16)/30)). Again, all column names and cells referenced are shown in FIGS. 2 and 7A-7H.

Total Ins $ (Column AH). This is the total UCC amount that must be paid for the invoice financing, as determined by the various parameters and constraints described above. It can be calculated as MIN((MAX(A3−B13,0)*B15),B14). All column names and cells referenced are shown in FIGS. 2 and 7A-7H.

Crowdz/Invoice Fund Administrator (FIG. 7D):

Raw Mo C % (Column AI). This is the raw (unadjusted) projected monthly Crowdz/Invoice Fund administrator rate of return, as adjusted by the parameters and constraints described above. It can be calculated as MIN(B9/(MAX(H3,B16)/30),((B17*52/12)−(AB3+AE3+AG3))). All column names and cells referenced are shown in FIGS. 2 and 7A-7H.

Final Mon C % (Column AJ). This is the final (adjusted) projected monthly Crowdz/Invoice Fund administrator rate of return, as determined by the adjusted by the parameters and constraints described above. In particular, the Crowdz/Invoice Fund administrator is adjusted such that preference is given to the Funder, allowing the Funder to receive its full due (within the limits of the parameters and constraints). The Crowdz/Invoice Fund administrator is calculated as AI3+(AI3/(AB3+AI3))*AA3. All column names and cells referenced are shown in FIGS. 2 and 7A-7H.

Total Crdz $ (Column AK). This is the total Crowdz/Invoice Fund administrator profit (return), based on the final projected monthly Crowdz/Invoice Fund administrator rate of return (Column AJ), the invoice amount (Column A), and the remaining term (Column H). It can be calculated as AJ3*A3*(H3)/30. All column names and cells referenced are shown in FIGS. 2 and 7A-7H.

Discount Rate (FIG. 7E):

Raw Mo D % (Column AL). The raw monthly discount rate is the provisional sum of the four sets of costs just described—in particular, the raw percentages shown in Columns AB, AE, AG, and AI. It can be calculated as (AB3+AE3+AG3+AI3). All column names and cells referenced are shown in FIGS. 2 and 7A-7H.

Final Mo D % (Column AM). The final monthly discount rate is the final sum of the four sets of costs just described—in particular, the final percentages shown in Columns AC, AE, AG, and AJ. Note that the percentages in Columns AE and AG are both provisional (raw) and final). The final monthly discount rate is calculated as AC3+AE3+AG3+AJ3. All column names and cells referenced are shown in FIGS. 2 and 7A-7H.

Total Disc % (Column AN). The total monthly discount rate is the product of the final monthly discount rate multiplied by the number of 30-day (monthly) periods in the remaining term (Column H). It can be calculated as AM3*(H3/30). All column names and cells referenced are shown in FIGS. 2 and 7A-7H.

Mo Disc $ (Column AO). The monthly discount charge is the amount of money that the Invoice Seller must pay on a monthly basis over the life of the invoice financing. It is the product of the final monthly discount rate (Column AM) and the invoice amount (Column A).

Total Disc $ (Column AP). The Total discount charge is the amount of money that the Invoice Seller must pay over the life of the invoice financing. It is the sum of the four total charges just described in Columns AD, AF, AH, and AK.

### APR Determination

The APR calculations are shown in FIG. 7E and are used to calculate the annual, weekly, and daily interest charges for invoice financing, as follows:

APR (Column AQ). The Invoice Seller's annual percentage rate (APR) is the total discount rate (Column AN) adjusted by maximum weekly interest rate for invoice financing (Cell B17). It can be calculated as MIN((AN3/(H3/30))*12,((B17/7)*365)). All column names and cells referenced are shown in FIGS. 2 and 7A-7H.

Wkly % (Column AR). The weekly interest rate for invoice financing is equal to the annual percentage rate (Column AQ) divided by 52 weeks.

Daily % (Column AS). The daily interest rate for invoice financing is equal to the annual percentage rate (Column AQQ) divided by 365 days. (Note: 365 days—rather than 12×30=360 days—is used in all annualization calculations described above.)

### Funding Amounts

The funding-amount calculations are shown in FIG. 7F and are used to determine the various high-level rates and charges used in the assessment of funding-related variables, as follows:

Funding Amount (Column AT). The funding amount, or the total amount that the Invoice Seller ultimately receives, is equal to one minus the total discount rate (Column AN) times the invoice amount (Column A).

Hdbk % (Column AU). The base holdback percentage is the adjusted value of the holdback percentage, taking into account the maximum holdback parameters (Cells B19 and B20) and the above-mentioned normalization factor (Column X). It can be calculated as B19+((B20−B19)*X3). All column names and cells referenced are shown in FIGS. 2 and 7A-7H.

Disc % (Column AV). The discount rate, as determined above, is copied here.

Total HB (Column AW). The total amount held back from the value of the invoice for the initial invoice-financing disbursement is equal to the sum of the base holdback percentage (Column AU) and the discount rate (Column AV).

Base HB $ (Column AX). The base holdback charge (monetary amount) is equal to the base holdback percentage (Column AU) times the invoice amount (Column A).

Disc HB $ (Column AY). The discount holdback charge (monetary amount) is equal to the discount rate (Column AV) times the invoice amount (Column A).

Total HB $ (Column AZ). The total holdback charge (monetary amount) is equal to sum of the base holdback charge (Column AX) and the discount holdback charge (Column AY).

Disburs % (Column BA). The disbursement percentage is equal to 100% less the sum of the discount rate (Column AN) and the base holdback percentage (Column AU).

Disbursed $ (Column BB). The total amount initially disbursed in the invoice financing is equal to the invoice amount (Column A) less the sum of the discount charge (Column AP) and the base holdback charge (Column AX).

### Repayment Parameters

The repayment parameters are shown in FIG. 7G and used to calculate various values related to invoice-funding repayments and penalties, as follows:

Repay Amount (Column BC). The repay amount is set by default equal to the amount of the invoice.

Alt Repay Amt (Column BD). The alternate repay amount gives Crowdz and/or the Invoice Fund administrator the option to allow Invoice Sellers to pay back on the amount funded plus the discount charge (i.e., not repay the holdback amount). In this case, rather than repay the full amount of the invoice and receive the holdback amount in return, the Seller simply would pay the full amount of the invoice less the holdback amount and receive nothing in return. This alternate repay amount is calculated as the invoice amount (Column A) less the base holdback charge (Column AX3).

Wkly Penalty (Column BE). The weekly penalty is equal to the weekly interest rate (Column AR) times the invoice amount (Column A).

Max Penalty (Column BF). The maximum penalty is equal, by definition, to the base holdback charge (Column AX). The concept is that, once the maximum fee is hit, the Invoice Seller is declared to be in default. In the event there is no base holdback charge, there is no holdback to cover any penalties. The penalties therefore continue to mount and can be charged, but there is no arithmetic maximum penalty since there is no base holdback charge to measure it against.

Max Wks (Column BG). The maximum number of weeks before default is declared is equal to the maximum penalty (Column BF) divided by the weekly penalty (Column BE). In the event there is no base holdback charge, there is no holdback to coverage any penalties and so no arithmetic maximum weeks to charge against. Penalties still can be charged and a determination still can be made as to when to declare the Invoice Seller to be in default, but there is no way to determine this a priori from the model.

### Outcomes

The outcomes calculations are shown in FIG. 7H and are used to illustrate the dynamics within the model when actual values of certain parameters become known, as follows:

Inv Term (Column BH). This is the remaining original remaining term of the financed invoice, as copied from Column H.

Act DBT (Column BI). This is the assumed (user-selected) actual days beyond term before the invoice-financing is repaid.

Act Reinv Dly (Column BJ). This is the assumed (user-selected) actual delay between the time the repayment is received and the time the repaid funds are reinvested in additional invoice financing.

Act Term (Column BL). This is the total number of days the repayment arrives late, given the above assumptions, and is the sum of the original remaining invoice term (Column BH), the actual DBT (Column BI), and the actual reinvestment delay (Column BJ).

Repayment (Column BL). This is the repayment amount (Column BC), which is equal to the invoice amount (Column A), from which the amount is copied.

Penalty (Column BM). This is the penalty the Seller would be charged, given the assumed days late. It can be calculated as the difference between the actual term (Column BK) less the original remaining term (Column BH) and less the actual reinvestment delay, since the Seller is not responsible for any delays in reinvesting funds once the invoice financing is repaid (Column BJ)—with all of this amount divided by 7 and multiplied by the weekly penalty (Column BE). By definition, it is assumed that the penalty cannot be negative—that is, there is no rebate—in the event of early payment, although this condition can be modified. In addition, it is assumed that penalties are charged for each day late (hence the division by seven), although the calculations could be modified so that penalties would be charged only after each full weeks of lateness.

Funder Base (Column BN). The Funder base is the total profit (in monetary terms) that the Funder would receive given projected values.

Funder Extra (Column BO). The Funder extra is the proportion of the penalty that the Funder would receive, which is proportional to the Funder's relative share of the sum of the Funder and Crowdz/Invoice Fund administrator bases. This amount is calculated as (AD3/(AD3+AK3))*BM3. All column names and cells referenced are shown in FIGS. 2 and 7A-7H.

Funder Total (Column BP). The Funder total is the sum of the Funder base (Column BN) and the Funder extra (Column BO).

Crowdz Base (Column BQ). The Crowdz/Invoice Fund administrator base is the total profit (in monetary terms) that Crowdz/the Invoice Fund administrator would receive given projected values.

Crowdz Extra (Column BR). The Crowdz/Invoice Fund administrator extra is the proportion of the penalty that Crowdz/the Invoice Fund administrator would receive, which is proportional to Crowdz's/the Invoice Fund administrator relative share of the sum of the Funder and Crowdz/Invoice Fund administrator bases. This amount is calculated as (AK3/(AD3+AK3))*BM3. All column names and cells referenced are shown in FIGS. 2 and 7A-7H.

Crowdz Total (Column BS). The Crowdz/Invoice Fund administrator total is the sum of the Crowdz/Invoice Fund administrator base (Column BQ) and the Crowdz/Invoice Fund administrator extra (Column BS).

Seller Rebate (Column BT). The Seller rebate is the amount that the Seller would receive back (or the amount that would not have to be paid) if the Seller repaid the invoice financing early and if rebates were allowed. The rebate (and the changes to the Funder total (Column BP) and the Crowdz/Invoice Fund administrator total (Column BS) would calculate automatically if negative values were allowed in the penalty calculation (Column BM).

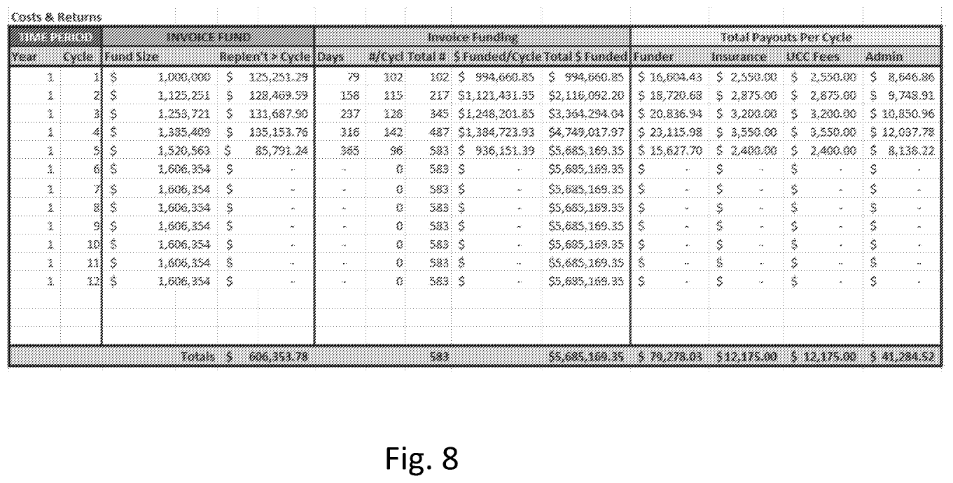

Once the invoice is priced properly is can be included in a fund and securitized. FIG. 8 illustrates an example of costs & returns relating to an invoice fund over a period of monthly cycles in a year according to an exemplary embodiment.

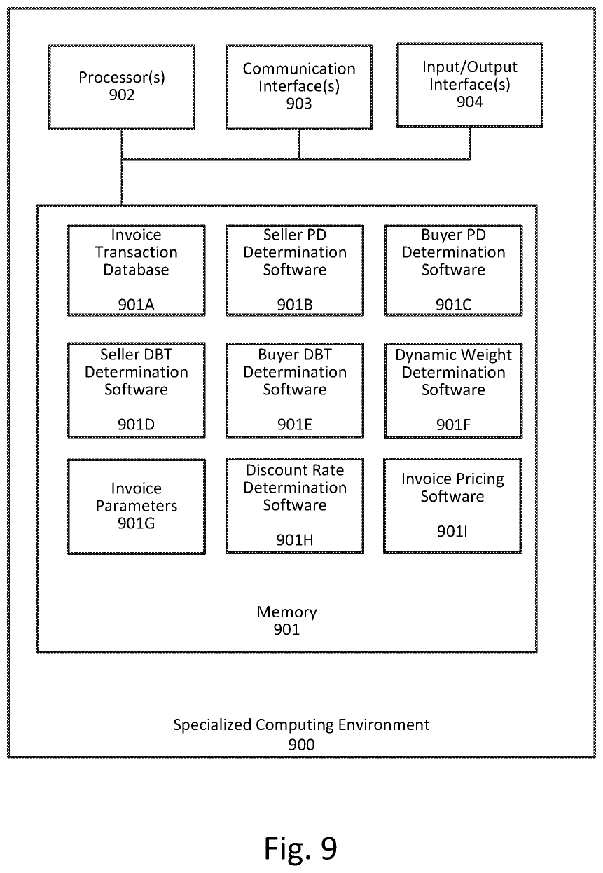

FIG. 9 illustrates the components of the specialized computing environment 900 configured to perform the specialized processes described herein. Specialized computing environment 900 is a computing device that includes a memory 901 that is a non-transitory computer-readable medium and can be volatile memory (e.g., registers, cache, RAM), non-volatile memory (e.g., ROM, EEPROM, flash memory, etc.), or some combination of the two.

As shown in FIG. 9, memory 901 can include invoice transaction database 901A, seller PD determination software 901B, buyer PD determination software 901C, seller DBT determination software 901D, buyer DBT determination software 901E, dynamic weight determination software 901F, invoice parameters 901G, discount rate determination software 901H, and invoice pricing software. Each of the software components in memory 901 store specialized instructions and data structures configured to perform the corresponding functionality and techniques described herein.

All of the software stored within memory 901 can be stored as a computer-readable instructions, that when executed by one or more processors 902, cause the processors to perform the functionality described with respect to FIGS. 1-8.

Processor(s) 902 execute computer-executable instructions and can be a real or virtual processors. In a multi-processing system, multiple processors or multicore processors can be used to execute computer-executable instructions to increase processing power and/or to execute certain software in parallel.

Specialized computing environment 900 additionally includes a communication interface 903, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 900 further includes input and output interfaces 904 that allow users (such as system administrators) to provide input to the system to set parameters, to edit data stored in memory 901, or to perform other administrative functions.

An interconnection mechanism (shown as a solid line in FIG. 9), such as a bus, controller, or network interconnects the components of the specialized computing environment 900.

Input and output interfaces 904 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 900.

Specialized computing environment 900 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 900.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

1. A method executed by one or more computing devices for dynamically modeling a current price of an invoice issued by a seller based on real-time monitoring of transaction data on a computer network, the method comprising:
receiving, by at least one of the one or more computing devices, invoice data corresponding to the invoice issued by the seller, the invoice data comprising a buyer identifier corresponding to a customer of the seller, a seller identifier corresponding to the seller, and one or more invoice parameters;
identifying, by at least one of the one or more computing devices, a buyer profile on an invoice transactions platform on the computer network based at least in part on the buyer identifier and a seller profile on the invoice transactions platform on the computer network based at least in part on the seller identifier, the buyer profile comprising a buyer transaction history and the seller profile comprising a seller transaction history;
determining, by at least one of the one or more computing devices, a seller overall probability of default based at least in part on a plurality of seller-default variables and a plurality of dynamic seller-default weights associated with the plurality of seller-default variables, wherein current values of the plurality of dynamic seller-default weights are determined based at least in part on real-time monitoring of transactions in the seller transaction history of the seller profile;
determining, by at least one of the one or more computing devices, a buyer overall probability of default based at least in part on a plurality of buyer-default variables and a plurality of dynamic buyer-default weights associated with the plurality of buyer-default variables, wherein current values of the plurality of dynamic buyer-default weights are determined based at least in part on real-time monitoring of transactions in the buyer transaction history of the buyer profile; and
determining, by at least one of the one or more computing devices, the current price of the invoice based at least in part on the seller overall probability of default, the buyer overall probability of default, and the one or more invoice parameters.

2. The method of claim 1, wherein the plurality of seller-default variables comprise a seller integrity score, one or more secondary probability of default scores associated with the seller, and a seller internal probability of default.

3. The method of claim 1, wherein the plurality of buyer-default variables comprise a buyer integrity score, one or more secondary probability of default scores associated with the buyer, and a buyer internal probability of default.

4. The method of claim 1, wherein the one or more invoice parameters comprise an invoice amount, an administrator fee, an insurance fee percentage, a uniform commercial code fee, a fee period, a maximum weekly interest rate, a maximum monthly interest rate, a base holdback percentage, a maximum base holdback percentage, an insurance repayment percentage, a fund size, a fund cycles parameter, an additional funding parameter, a funder profit retention flag, a funder profit retention percentage, an administrator profit retention flag, an administrator profit retention percentage.

5. The method of claim 1, wherein determining the current price of the invoice based at least in part on the seller overall probability of default, the buyer overall probability of default, and the one or more invoice parameters comprises:
determining values of funder profit, invoice insurance, universal commercial code fees, and administrator profit required to reach a target annualized internal rate of return for an investor financing the invoice based at least in part on the seller overall probability of default, the buyer overall probability of default, and the one or more invoice parameters; and
determining a total discount rate based at least in part on the determined values of the funder profit, the invoice insurance, the universal commercial code fees, and the administrator profit; and
determining the current price of the invoice based at least in part on the total discount rate.

6. The method of claim 5, wherein determining the current price of the invoice based at least in part on the total discount rate comprises:
multiplying an invoice amount by the total discount rate to determine a discount value; and
subtracting the discount value from the invoice amount to determine the current price of the invoice.

7. An apparatus for dynamically modeling a current price of an invoice issued by a seller based on real-time monitoring of transaction data on a computer network, the apparatus comprising:
one or more processors; and
one or more memories operatively coupled to at least one of the one or more processors and having instructions stored thereon that, when executed by at least one of the one or more processors, cause at least one of the one or more processors to:
receive invoice data corresponding to the invoice issued by the seller, the invoice data comprising a buyer identifier corresponding to a customer of the seller, a seller identifier corresponding to the seller, and one or more invoice parameters;
identify a buyer profile on an invoice transactions platform on the computer network based at least in part on the buyer identifier and a seller profile on the invoice transactions platform on the computer network based at least in part on the seller identifier, the buyer profile comprising a buyer transaction history and the seller profile comprising a seller transaction history;
determine a seller overall probability of default based at least in part on a plurality of seller-default variables and a plurality of dynamic seller-default weights associated with the plurality of seller-default variables, wherein current values of the plurality of dynamic seller-default weights are determined based at least in part on real-time monitoring of transactions in the seller transaction history of the seller profile;
determine a buyer overall probability of default based at least in part on a plurality of buyer-default variables and a plurality of dynamic buyer-default weights associated with the plurality of buyer-default variables, wherein current values of the plurality of dynamic buyer-default weights are determined based at least in part on real-time monitoring of transactions in the buyer transaction history of the buyer profile; and
determine the current price of the invoice based at least in part on the seller overall probability of default, the buyer overall probability of default, and the one or more invoice parameters.

8. The apparatus of claim 7, wherein the plurality of seller-default variables comprise a seller integrity score, one or more secondary probability of default scores associated with the seller, and a seller internal probability of default.

9. The apparatus of claim 7, wherein the plurality of buyer-default variables comprise a buyer integrity score, one or more secondary probability of default scores associated with the buyer, and a buyer internal probability of default.

10. The apparatus of claim 7, wherein the one or more invoice parameters comprise an invoice amount, an administrator fee, an insurance fee percentage, a uniform commercial code fee, a fee period, a maximum weekly interest rate, a maximum monthly interest rate, a base holdback percentage, a maximum base holdback percentage, an insurance repayment percentage, a fund size, a fund cycles parameter, an additional funding parameter, a funder profit retention flag, a funder profit retention percentage, an administrator profit retention flag, an administrator profit retention percentage.

11. The apparatus of claim 7, wherein the instructions that, when executed by at least one of the one or more processors, cause at least one of the one or more processors to determine the current price of the invoice based at least in part on the seller overall probability of default, the buyer overall probability of default, and the one or more invoice parameters further cause at least one of the one or more processors to:
determine values of funder profit, invoice insurance, universal commercial code fees, and administrator profit required to reach a target annualized internal rate of return for an investor financing the invoice based at least in part on the seller overall probability of default, the buyer overall probability of default, and the one or more invoice parameters; and
determine a total discount rate based at least in part on the determined values of the funder profit, the invoice insurance, the universal commercial code fees, and the administrator profit; and
determine the current price of the invoice based at least in part on the total discount rate.

12. The apparatus of claim 11, wherein the instructions that, when executed by at least one of the one or more processors, cause at least one of the one or more processors to determine the current price of the invoice based at least in part on the total discount rate further cause at least one of the one or more processors to:
multiply an invoice amount by the total discount rate to determine a discount value; and
subtract the discount value from the invoice amount to determine the current price of the invoice.

13. At least one non-transitory computer-readable medium storing computer-readable instructions that, when executed by one or more computing devices, cause at least one of the one or more computing devices to:
receive invoice data corresponding to an invoice issued by the seller, the invoice data comprising a buyer identifier corresponding to a customer of the seller, a seller identifier corresponding to the seller, and one or more invoice parameters;
identify a buyer profile on an invoice transactions platform on the computer network based at least in part on the buyer identifier and a seller profile on the invoice transactions platform on the computer network based at least in part on the seller identifier, the buyer profile comprising a buyer transaction history and the seller profile comprising a seller transaction history;
determine a seller overall probability of default based at least in part on a plurality of seller-default variables and a plurality of dynamic seller-default weights associated with the plurality of seller-default variables, wherein current values of the plurality of dynamic seller-default weights are determined based at least in part on real-time monitoring of transactions in the seller transaction history of the seller profile;
determine a buyer overall probability of default based at least in part on a plurality of buyer-default variables and a plurality of dynamic buyer-default weights associated with the plurality of buyer-default variables, wherein current values of the plurality of dynamic buyer-default weights are determined based at least in part on real-time monitoring of transactions in the buyer transaction history of the buyer profile; and
determine the current price of the invoice based at least in part on the seller overall probability of default, the buyer overall probability of default, and the one or more invoice parameters.

14. The at least one non-transitory computer-readable medium of claim 13, wherein the plurality of seller-default variables comprise a seller integrity score, one or more secondary probability of default scores associated with the seller, and a seller internal probability of default.

15. The at least one non-transitory computer-readable medium of claim 13, wherein the plurality of buyer-default variables comprise a buyer integrity score, one or more secondary probability of default scores associated with the buyer, and a buyer internal probability of default.

16. The at least one non-transitory computer-readable medium of claim 13, wherein the one or more invoice parameters comprise an invoice amount, an administrator fee, an insurance fee percentage, a uniform commercial code fee, a fee period, a maximum weekly interest rate, a maximum monthly interest rate, a base holdback percentage, a maximum base holdback percentage, an insurance repayment percentage, a fund size, a fund cycles parameter, an additional funding parameter, a funder profit retention flag, a funder profit retention percentage, an administrator profit retention flag, an administrator profit retention percentage.

17. The at least one non-transitory computer-readable medium of claim 13, wherein the instructions that, when executed by at least one of the one or more computing devices, cause at least one of the one or more computing devices to determine the current price of the invoice based at least in part on the seller overall probability of default, the buyer overall probability of default, and the one or more invoice parameters further cause at least one of the one or more computing devices to:
determine values of funder profit, invoice insurance, universal commercial code fees, and administrator profit required to reach a target annualized internal rate of return for an investor financing the invoice based at least in part on the seller overall probability of default, the buyer overall probability of default, and the one or more invoice parameters; and
determine a total discount rate based at least in part on the determined values of the funder profit, the invoice insurance, the universal commercial code fees, and the administrator profit; and
determine the current price of the invoice based at least in part on the total discount rate.

18. The at least one non-transitory computer-readable medium of claim 17, wherein the instructions that, when executed by at least one of the one or more processors, cause at least one of the one or more processors to determine the current price of the invoice based at least in part on the total discount rate further cause at least one of the one or more processors to:
multiply an invoice amount by the total discount rate to determine a discount value; and
subtract the discount value from the invoice amount to determine the current price of the invoice.
